(19) United States
(12) Patent Application Publication
(10) Pub. No.: US 2008/0016956 A1
(43) Pub. Date: Jan. 24, 2008

(54) Mechanical Synchronized Mass Flow Controller

(76) Inventor: Young-Chul Chang, Songpa-ku (KR)

Correspondence Address: BEYER WEAVER LLP, P.O. BOX 70250, OAKLAND, CA, 94612-0250, US

(21) Appl. No.: 11/667,588

(22) PCT Filed: Nov. 11, 2005
(86) PCT No.: PCT/KR05/03822

§ 371 Date: Sep. 14, 2007

(30) Foreign Application Priority Data
Nov. 12, 2004 (KR) 10 2004-0092465

(51) Int. Cl. G05D 7/00

(52) U.S. Cl. 73/199; 73/203; 73/861.351

(57) ABSTRACT

The mechanical synchronized time-based mass flow controller can control the flow rate easily and precisely. The mechanical synchronized time-based mass flow controller includes a reservoir 1a, 1b, an inlet line 14, an outlet line 24, a valve 3 and a control unit. The valve 3 has a passage 3a through which the fluid passes and operates in a mechanical cycle which includes an inlet line open period when the passage 3a is communicated with the inlet line 14 and the inlet line 14 is in an open state and an outlet line open period when the passage 3a is communicated with the outlet line 24 and the outlet line 24 is in an open state according to change of position of the passage 3a, the inlet line open period and the outlet line open period coming out of phase with each other so that the inlet line 14 can be opened when the outlet line 24 is in a closed state and the outlet line 24 can be opened when the inlet line 14 is in a closed state. The control unit controls cycle rate of the valve 3 and/or mass/volume of the fluid stored and discharged at the reservoir 1a, 1b per unit opening/closing cycle of the valve 3, to control mass/volume flow rate of the outflow fluid from the reservoir 1a, 1b.

### TECHNICAL FIELD

This Invention relates to a time based mass flow controller and, more particularly, a mechanical synchronized time-based mass flow controller which can control the flow rate easily and precisely.

### BACKGROUND ART

Mass flow controllers (MFCs) are used in various fields such as electronic equipments, fluid equipments, etc. For instance, in the manufacturing processes for semiconductor devices, the amount of supply gas must be accurately controlled. Furthermore, the remarkable size reduction of semiconductor devices through the improvement of integration techniques requires the flow rate of supply gas to be controlled more accurately.

However, the flow rate is very difficult to measure directly. As disclosed in U.S. Pat. Nos. 6,044,701, 5,279,154, 4,686,856 and Japanese Unexamined Patent Publication No. S59-88622, various kinds of mass flow controllers and meters have been suggested and used. However, most of them are complex and expensive in installation and maintenance. That is, conventional MFCs are highly specialized and expensive equipment.

To solve the above problem, the inventor has adopted a novel concept completely different from that of conventional MFCs, and has suggested a mass flow controller which is easy to control and can measure precisely and easily through PCT Publication Nos. WO 2002/054020, WO 2004/017150, and WO 2004/036153. These mass flow controllers measure and control the flow rate based on time which can be measured more accurately and cheaply than any other physical value, for example, by using a quartz crystal timing device. These mass flow controller can control the flow rate without using an accurate implement.

These mass flow controllers are as follows.

FIG. 1 schematically shows a concept of a conventional time-based mass flow controller for a compressible fluid suggested in an inventor's previous application, the PCT Publication No. WO 2002/054020.

A mass flow controller in FIG. 1 includes a reservoir 1a; an inlet valve 13 opening/closing an inlet of the reservoir 1a; an outlet valve 23 opening/closing an outlet of the reservoir 1a; a pressure sensor 5 detecting a gas pressure in the reservoir 1a; and a control unit for controlling the number of opening/closing loops of the inlet valve 13 and the outlet valve 23 per unit time and/or mass/volume of a gas stored and discharged at the reservoir 1a per unit opening/closing loop of the inlet valve 13 and the outlet valve 23 so as to control the mass/volume flow rate of the outflow gas from the reservoir 1a, with the inlet valve 13 opening the inlet of the reservoir 1a to allow the gas to flow into the reservoir 1a when the outlet valve 23 is in a closed state, and thereafter the outlet valve 23 opening the outlet of the reservoir 1a to allow the gas to flow out from the reservoir 1a when the inlet valve 13 is in a closed state.

Preferably, the mass flow controller includes a pressure regulator 11 on an upstream side of the inlet of the reservoir 1a, the regulator 11 regulating the gas pressure of the inflow gas into the reservoir 1a to be constant. In addition, the mass flow controller can include a buffer 15 installed on a downstream side of the outlet of the reservoir 1a, the buffer 15 preventing perturbation of the outflow gas out of the reservoir 1a.

The compressible working gas whose pressure has been regulated to be constant by the pressure regulator 11 flows into the reservoir 1a when the inlet valve 13 is opened. At this time, the outlet valve 23 is in a closed state. Later, when the pressure in the reservoir 1a reaches a pre-set value, the inlet valve 13 is closed and the outlet valve 23 is opened. The working gas flows out of the reservoir 1a and flow into the buffer 15 with a larger volume than the reservoir 1a.

The mass flow controller in FIG. 1 is based on the simple method, ‘bucket & stop watch’ method. Fill the bucket of a known mass/volume with water and then empty the bucket. Repeat this work. Then, calculate ‘the number of filling/emptying works×the mass/volume of the bucket’, which enables us to find out the flow rate. In addition, we can control the flow rate by controlling the value of each term in the above calculation.

The mass flow controller in FIG. 1 is a very useful tool for controlling the flow rate of a compressible gas but it has a limitation that it cannot be applied for an incompressible fluid. The mass flow controller in FIG. 1 is based on a fixed volume reservoir 1a. Accordingly, unless inlet conditions of the reservoir 1a are changed, the mass of an incompressible fluid stored and discharged at the reservoir 1a per unit cycle cannot be changed. To solve the above limitation, the inventor has suggested a mass flow controller in FIG. 2 which can be applied for an incompressible fluid.

FIG. 2 schematically shows a concept of a time-based mass flow controller for an incompressible fluid suggested in another inventor's previous application, the PCT Publication No. WO 2004/017150.

The mass flow controller in FIG. 2 includes a reservoir 1b whose volume changes in a cycle, instead of a fixed volume reservoir 1a.

FIGS. 3 and 4 schematically show a concept of a mechanical synchronized mass flow controller suggested in another previous application of the inventor, the PCT Publication No. WO 2004/036153.

Mass flow controllers in FIGS. 3 and 4 include a reservoir 1a, 1b; an inlet valve 13 opening/closing an inlet of the reservoir 1a, 1b in a cycle in which an inlet open period when the inlet of the reservoir 1a, 1b is in an open state alternates with an inlet closed period when the inlet of the reservoir is in a closed state; an outlet valve 23 opening/closing an outlet of the reservoir 1a, 1b in a cycle in which an outlet closed period when the outlet of the reservoir 1a, 1b is in a closed state alternates with an outlet open period when the outlet of the reservoir 1a, 1b is in an open sate; and a control unit controlling opening/closing cycle rates of the inlet valve 13 and the outlet valve 23 and/or mass/volume of fluid stored and discharged at the reservoir 1a, 1b per unit opening/closing cycle of the inlet valve and the outlet valve, to control mass/volume flow rate of the outflow fluid from the reservoir 1a, 1b.

The inlet valve 13 and the outlet valve 23 are provided at a constant rate with such an amount of driving force that a periodic time of the opening/closing cycle of the inlet valve 13 equals that of the outlet valve 23.

The inlet open period and the outlet open period come out of phase with each other so that the inlet valve 13 can be opened when the outlet valve 23 is in a closed state and the outlet valve 23 can be opened when the inlet valve 13 is in a closed state.

However, the flow controllers in FIGS. 1 to 4 have a problem that their control performance is not good. In the flow controllers in FIGS. 1 to 4, it is essential that the inlet valve 13 and the outlet valve 23 have to be synchronized with each other. If there is a little error in opening/closing operations of the inlet valve 13 and the outlet valve 23, that is, if the inlet valve 13 or the outlet valve 23 rotates a little rapidly or a little slowly, flow rate accuracy deteriorates very much. Furthermore, because the inlet valve 13 and the outlet valve 23 continuously repeat their opening/closing operations, errors once produced are accumulated and at last the inlet valve 13 and the outlet valve 23 may be in an open state at the same time. This means that they cannot function as a flow controller.

In addition, it is necessary to accurately adjust phases of the valves 13, 23 before operating the flow controllers, and-thus it is more difficult to control the flow rate in the flow controllers in FIGS. 1 to 4. For example, if the inlet valve 13 and the outlet valve 23 are in an open state at the same time but nevertheless an operator starts to operate the flow controllers in FIGS. 1 to 4 without adjusting phases of the valves 13, 23 (for example, to be 90 degrees between them), they cannot function as a flow controller.

In addition, the flow controllers in FIGS. 1 to 4 need two precision valves 13, 23. This causes the flow controllers to be expensive and hinders them from being compact.

In addition, two valves 13, 23 of the flow controllers in FIGS. 1 to 4 generate vibration and noise. A vibration problem in the flow controller, especially used in the manufacturing process for semiconductor devices requiring high precision, is very serious, because it can cause a very bad effect on quality of semiconductor devices.

### DISCLOSURE OF INVENTION

The present invention is made to solve the above problems.

An object of the present invention is to provide a mass flow controller which keeps advantages of the inventor's previous inventions and besides has excellent controllability.

Another object of the present invention is to provide a mass flow controller which has high reliability by minimizing the possibility of control errors.

Yet another object of the present invention is to provide a mass flow controller which is inexpensive and compact.

Yet another object of the present invention is to provide a mass flow controller which can provide silent environment by minimizing vibration and noise.

To achieve the above object, the present invention provides a mechanical synchronized time-based mass flow controller comprising a reservoir; an inlet line communicated with the reservoir through which fluid flows into the reservoir; an outlet line communicated with the reservoir through which the fluid flows out from the reservoir; a valve having a passage through which the fluid passes and operating in a mechanical cycle which includes an inlet line open period when the passage is communicated with the inlet line and the inlet line is in an open state and an outlet line open period when the passage is communicated with the outlet line and the outlet line is in an open state according to change of position of the passage, the inlet line open period and the outlet line open period coming out of phase with each other so that the inlet line can be opened when the outlet line is in a closed state and the outlet line can be opened when the inlet line is in a closed state; and a control unit controlling cycle rate of the valve and/or mass/volume of the fluid stored and discharged at the reservoir per unit opening/closing cycle of the valve, to control mass/volume flow rate of the outflow fluid from the reservoir.

Preferably, the valve is a rotary type valve.

According to an embodiment of the present invention, the inlet line and the outlet line cross each other, the valve is a ball valve installed at a place where the inlet line and the outlet line cross each other, and the ball valve is rotated to alternately open the inlet line and the outlet line out of phase.

According to another embodiment of the present invention, the passage of the valve has an opening facing in the direction of a rotation shaft of the valve and meets the inlet line and the outlet line out of phase on the rotation route of the passage, and the valve is rotated to alternately opens the inlet line and the outlet line out of phase.

According to yet another embodiment of the present invention, the inlet line and/or outlet line is installed in the plural number respectively. In addition, it is possible that the valve has plural passages. Furthermore, it is also possible that the inlet line and/or outlet line is installed in the plural number respectively and at the same time the valve has plural passages.

According to yet another embodiment of the present invention, the flow controller includes plural valves installed on a single shaft, and each valve alternately opens the corresponding inlet line and the corresponding outlet line out of phase.

According to yet another embodiment of the present invention, if there are plural inlet lines, different fluids are flow into the reservoir through the plural inlet lines.

The present invention provides a mechanical synchronized time-based mass flow controller comprising a reservoir; an inlet line communicated with the reservoir through which fluid flows into the reservoir; an outlet line communicated with the reservoir through which the fluid flows out from the reservoir; a valve rotating on a single shaft in a mechanical cycle which includes an inlet line open period when the inlet line is in an open state and an outlet line open period when the outlet line is in an open state, the inlet line open period and the outlet line open period coming out of phase with each other so that the inlet line can be opened when the outlet line is in a closed state and the outlet line can be opened when the inlet line is in a closed state; and a control unit controlling cycle rate of the valve and/or mass/volume of the fluid stored and discharged at the reservoir per unit opening/closing cycle of the valve, to control mass/volume flow rate of the outflow fluid from the reservoir.

According to yet another embodiment of the present invention, the valve has both an inlet valve and an outlet valve installed separately on the single shaft and rotating in one body, and the inlet valve opens the inlet line and the outlet valve opens the outlet line out of phase.

Preferably, the control unit controls the amount of driving force provided to the valve, to control the mass/volume flow rate of the outflow fluid from the reservoir.

Preferably, the flow controller includes a pressure sensor detecting pressure in the reservoir, and the control unit determines the amount of the driving force provided to the valve based on the pressure in the reservoir detected by the pressure sensor.

Preferably, the valve is provided with such an amount of the driving force that the cycle rate of the valve is lower than a critical cycle rate below which the pressure in the reservoir can rise to upstream pressure of the inlet line and drop to downstream pressure of the outlet line.

If the flow controller is for incompressible fluid, volume of the reservoir is preferably changed in a cycle.

Preferably, the flow controller includes a volume sensor detecting the volume of the reservoir, and the control unit determines the amount of the driving force provided to the valve based on the volume of the reservoir detected by the volume sensor.

### BRIEF DESCRIPTION OF DRAWINGS

FIG. 1 schematically shows a concept of a conventional time-based mass flow controller for compressible fluid suggested in a previous application of the inventor.

FIG. 2 schematically shows a concept of a time-based mass flow controller for incompressible fluid suggested in another previous application of the inventor.

FIGS. 3 and 4 schematically show a concept of a mechanical synchronized mass flow controller suggested in yet another inventor's previous application, wherein FIG. 3 shows the flow controller for compressible fluid and FIG. 4 shows the flow controller for incompressible fluid.

FIG. 5 schematically shows a concept of a mechanical synchronized time-based mass flow controller for compressible fluid according to an embodiment of the present invention.

FIGS. 6 and 7 schematically show modified embodiments of the flow controller of FIG. 5.

FIG. 8 schematically shows a concept of a mechanical synchronized time-based mass flow controller for a compressible fluid according to another embodiment of the present invention.

FIGS. 9 and 10 schematically show modified embodiments of the flow controller of FIG. 8.

FIG. 11 schematically shows a concept of a mechanical synchronized time-based mass flow controller for compressible fluid according to yet another embodiment of the present invention.

FIG. 12 shows open/closed states of the inlet line and the outlet line according to a phase of an opening/closing cycle.

FIG. 13 shows pressure change in the reservoir in FIG. 5.

FIG. 14 shows that the pressure change in the reservoir in FIG. 5 is affected by rotational speeds of a valve.

FIG. 15 shows the pressure change in the reservoir in FIG. 5 when the rotational speeds of the valve are considerably lower than a critical rotational speed.

FIG. 16 shows relation between the rotational speeds of the valve and a flow rate, wherein the flow rate is affected by difference between upstream pressure P₁ and downstream pressure P₂.

FIG. 17 schematically shows a concept of a mechanical synchronized time-based mass flow controller for incompressible fluid according to yet another embodiment of the present invention.

FIG. 18 shows volume change of the reservoir in FIG. 17.

FIG. 19 shows relation between the rotational speeds of the valve and the flow rate, wherein the flow rate is affected by difference between V₁ and V₂.

### BEST MODE FOR CARRYING OUT THE INVENTION

A mechanical synchronized time-based mass flow controller and a method for controlling flow rate using it in accordance with the present invention will now be described in detail with reference to the accompanying drawings.

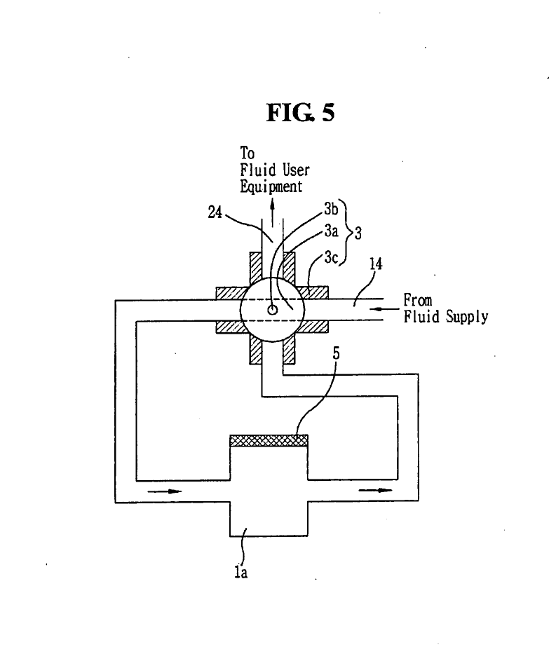

FIG. 5 schematically shows a concept of a mechanical synchronized time-based mass flow controller for compressible fluid according to an embodiment of the present invention.

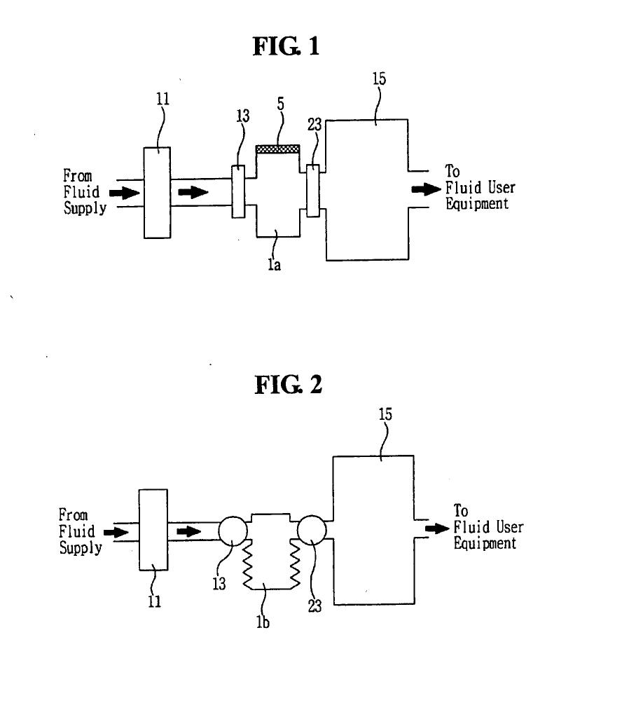

The flow controller of FIG. 5 includes a reservoir 1a, an inlet line 14, an outlet line 24, a valve 3 and a control unit. Although not shown, a pressure regulator 11 and a buffer 16 can be included in the flow controller of FIG. 5 like the flow controller of FIG. 1

The inlet line 14 is communicated with the reservoir 1a and allows fluid to flow from a fluid supply to the reservoir 1a. The outlet line 24 is communicated with the reservoir 1a and allows the fluid to flow from the reservoir 1a to a fluid user equipment.

The control unit controls opening/closing cycle rate of the valve 3 and/or mass/volume of the fluid stored and discharged at the reservoir 1a per unit cycle of the valve 3, to control mass/volume flow rate of the outflow fluid from the reservoir.

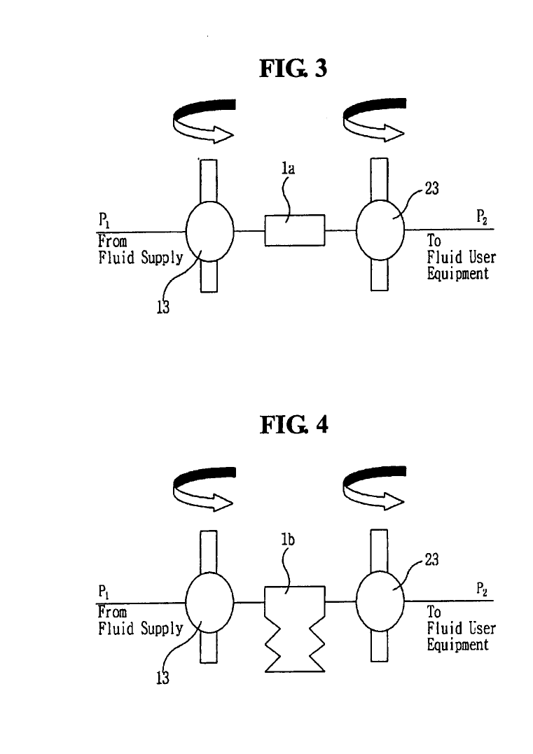

A requirement that the inlet valve 13 and the outlet valve 23 have to be synchronized with each other in the flow controller of FIG. 3 can be easily satisfied by opening/closing both the inlet line 14 and the outlet line 24 with the single valve 3.

The valve 3 has a passage 3a through which the fluid passes.

The valve 3 operates in a mechanical cycle which includes an inlet line open period and an outlet line open period, the inlet line open period and the outlet line open period coming out of phase with each other so that the inlet line can be opened when the outlet line is in a closed state and the outlet line can be opened when the inlet line is in a closed state. During the inlet line open period, the passage 3a is communicated with the inlet line 14 to open the inlet line 14 as shown in FIG. 5. During the outlet line open period, a position of the passage 3a is changed (by 90 degrees from the position in FIG. 5) such that the passage 3a is communicated with the outlet line 24 to open the outlet line 24.

The valve 3 is rotated on a single shaft 3b in the flow controller in FIG. 5 and thus opening/closing of the inlet line 14 and opening/closing of the outlet line 24 can be automatically synchronized. Therefore, it is very easy to control the flow rate and it is possible to obtain excellent control accuracy without a precise structure and a lot of effort in control. In addition, because an initial adjustment is not necessary, it becomes much easier to control the flow rate.

In addition, because the flow controller has only the single valve 3, it is possible to reduce cost and size of the flow controller and vibration and noise.

Although FIG. 5 shows the rotary type valve 3 rotated on the shaft 3b, various modifications such as a translation moving type valve are possible. However, the rotary type valve is preferable to the translation moving type valve in view of control efficiency.

In FIG. 5, the inlet line 14 and the outlet line 24 are installed to cross each other. A ball valve is used as the valve 3 and is installed at a place where the inlet line 14 and the outlet line 24 cross each other. The ball valve is rotated on the rotation shaft 3b. The inlet line 14 is opened when the passage 3a is communicated with the inlet line 14 and the outlet line 24 is opened when the passage 3a is communicated with the outlet line 24. This operation is continuously repeated performing one cycle per 180° rotation of the valve 3. That is, the ball valve alternately opens either the inlet line 14 or the outlet line with phase difference of 90 degrees.

The reference numeral 3c denotes a housing of the valve 3. A driving means, for example a motor, to drive the shaft 3b is not shown in the figure.

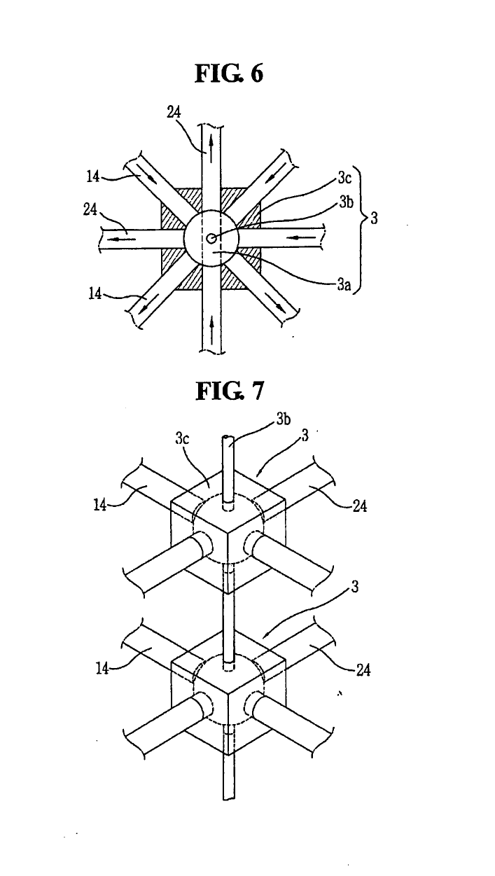

FIGS. 6 and 7 schematically show modified embodiments of the flow controller of FIG. 5.

As shown in FIG. 6, two inlet lines 14 and two outlet lines 24 meet the single ball valve 3.

The flow controller of FIG. 7 includes two ball valves which rotate on the single shaft 3b to rotate in one body. Each ball valve meets the corresponding inlet line 14 and the corresponding outlet line 24. That is, two sets of the inlet line 14, the outlet line 24 and the ball valve shown in FIG. 5 are provided on the upper side and the lower side. Each ball valve alternately opens the corresponding inlet line 14 and the corresponding outlet line 24 out of phase.

In FIG. 7, plural reservoirs 1a can be installed in parallel in the same number as the ball valves. In this case, rotating the valves out of phase can minimize perturbation of the flow rate flowing into the fluid user equipment.

The flow controllers in FIGS. 6 and 7 can be constructed to have the single reservoir into which various fluids flow through plural the inlet lines. In this case, the flow controller is used for mixing various fluids and then providing the mixed fluids for the fluid user equipment at a constant flow rate.

Through the embodiments in FIGS. 6 and 7, it is possible to control the flow rate of more various amounts.

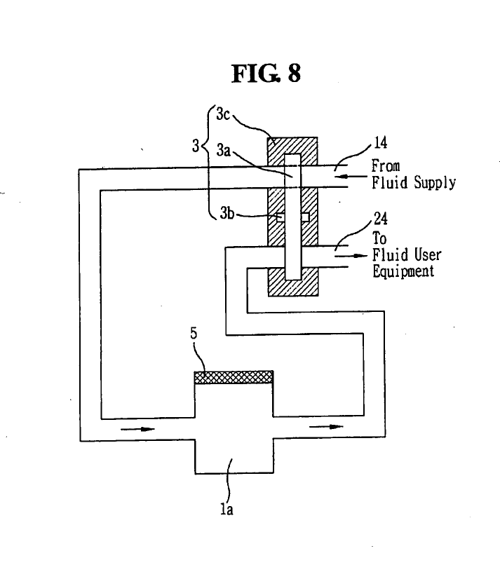

FIGS. 5 to 7 show the ball valve as the valve 3 but valves as in FIGS. 8 to 10 can be also used.

FIG. 8 schematically shows a concept of a mechanical synchronized time-based mass flow controller for compressible fluid according to another embodiment of the present invention.

As shown in FIG. 8, the passage 3a of the valve 3 is typically formed to go through in parallel with the shaft 3b. However, it is also possible that the passage 3a has an opening just facing in the direction of the shaft 3b. Furthermore, FIG. 8 shows that the inlet line 14 and the outlet line 24 is in parallel with the shaft 3b, but another embodiment is also possible.

In addition, FIGS. 8 to 10 show a disc shape valve but another embodiment of the valve with a different shape is also possible.

The passage 3a meets the inlet line 14 and the outlet line 24 out of phase on a rotation route of the passage.

While the valve 3 is rotating, the passage 3a of the valve 3 meets the inlet line 14 and the outlet line 24 out of phase, and thus the valve 3 can alternately open/close the inlet line 14 and the outlet line 24 out of phase.

When the passage 3a is communicated with the inlet line 14 as shown in FIG. 8, the inlet line 14 is opened. When the valve 3 is rotated by 180 degrees and the passage 3a is communicated with the outlet line 24, the outlet line 24 is opened.

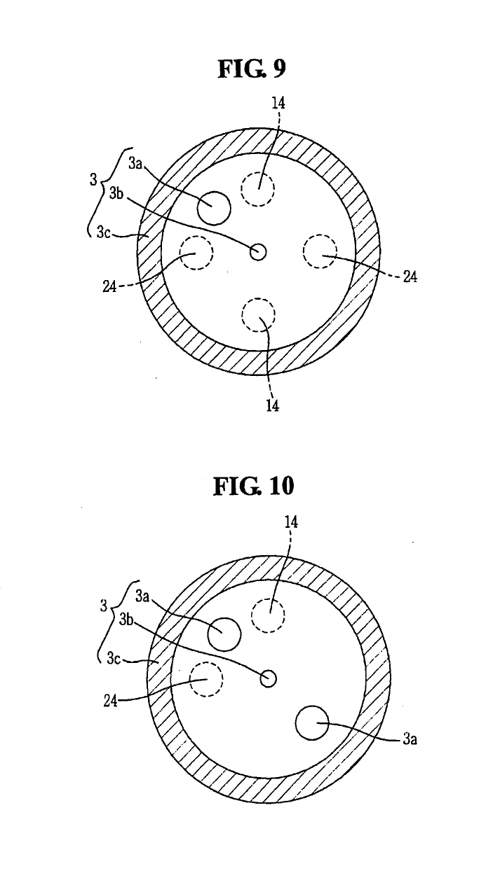

FIGS. 9 and 10 schematically show modified embodiments of the flow controller of FIG. 8.

FIG. 9, like FIG. 6, shows an embodiment of a flow controller having a single valve 3, plural inlet lines 14 and plural outlet lines 24.

FIG. 10 shows yet another embodiment of a flow controller in which a valve 3 has plural passages 3a. Both an inlet line 14 and an outlet line 24 have two open periods every rotation of the valve 3.

Another modified embodiment combining FIG. 9 and FIG. 10 is possible. For example, a flow controller can have a valve 3 with plural passages 3a together with plural inlet lines 14 and plural outlet lines 24.

FIGS. 9 and 10 also enable us to control the flow rate of more various amounts.

In the flow controllers of FIGS. 5 to 10, the valve 3 meets at least one inlet line 14 and one outlet line 24. This means that we can construct the flow controller with only one valve 3. Although FIG. 7 uses two valves 3, it is merely expansion from the single valve 3 which can fully function by itself.

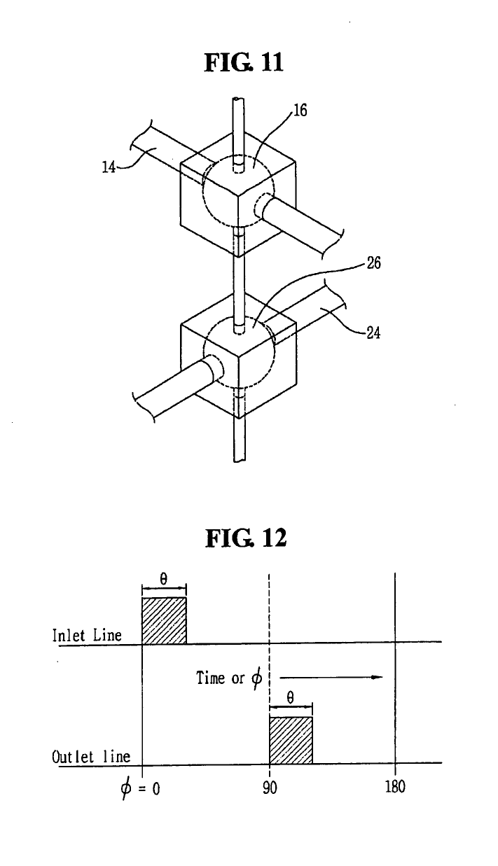

According to yet another embodiment of the present invention, a flow controller in FIG. 11 is possible but it is not preferable in view of cost and size.

FIG. 11 schematically shows a concept of a mechanical synchronized time-based mass flow controller for compressible.

The valve 3 has both an inlet valve 16 and an outlet valve 26 similarly to FIG. 3, but the inlet valve 16 and the outlet valve 26 have the same shaft and thus are rotated in one body. Therefore, an effort for synchronizing the inlet valve 16 and the outlet valve 26 is not necessary and thus controllability and accuracy is improved.

The flow controllers in FIGS. 5 to 11 can control the mass/volume flow rate of the outflow fluid from the reservoir 1a by controlling the amount of a driving force provided to the valve 3, for example rotation speed of the driving shaft.

FIG. 12 shows open/closed states of the inlet line 14 and the outlet line 24 according to the phase of the opening/closing cycle.

As shown in the figure, the inlet line 14 is opened first for a short period and then closed. Thereafter, the outlet line 24 is opened for a short period and then closed.

The open period of the inlet line 14 comes separately from the open period of the outlet line 24 so that the inlet line 14 can be opened while the outlet line 24 is in a closed state and the outlet line 24 can be opened while the inlet line 14 is in a closed state.

The open period of θ comes every 180° rotation of the ball valve. Here, θ is width of the open period. An open rate, σ is θ/180 and 0 <σ<1.

The inlet line 14 is opened when the phase φ of the valve 3 becomes 0° and is closed when the phase φ of the valve 3 becomes θ°. The outlet line 24 which initially is in a closed state is opened when the phase φ of the valve 3 becomes 90° and is closed when the phase φ of the valve 3 becomes 90° +θ°. That is, the width of the open periods of inlet line 14 and the outlet line 24 is θ° and a starting point of the inlet line open period and a starting point of the outlet line period are out of phase by 90°.

Another cycle starts when φ becomes 180° and thus two cycles are performed every rotation of the valve 3.

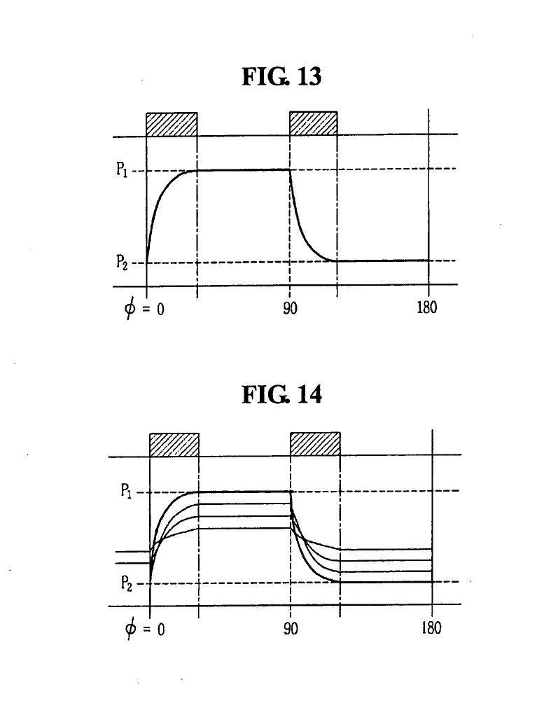

FIG. 13 shows the pressure change in the reservoir 1a in FIG. 5.

The pressure in the reservoir 1a initially increases rapidly as the inlet line 14 is opened. Once the inlet line 14 is closed, the pressure remains fixed until the outlet line 24 is opened. Once the outlet line 24 is opened, the pressure drops.

Assuming that the upstream pressure of the inlet line 14 is P₁ and the downstream pressure of the outlet line is P₂, the maximum pressure that the reservoir 1a can attain is P₁, and the minimum pressure is P₂. Whether the reservoir 1a reaches these limits depends on the length of time that the valve 3 is opened and the topology (hydrodynamic characteristics of the valve 3 and the reservoir 1a).

The figure suggests that the reservoir 1a attains pressures approaching P₁ and P₂. This can always be guaranteed by running the valve 3 sufficiently slowly. As the valve 3 is rotated at a faster speed (increasing the number of cycles performed per unit time), there is a danger that the reservoir 1a does not reach the supply pressure, P₁ or is not able to drop to the delivery pressure, P₂.

FIG. 14 shows that the pressure change in the reservoir 1a in FIG. 5 is affected by the rotational speed of the valve.

As shown in the figure, the pressure in the reservoir 1a is unable to attain P₁ or P₂ depending on the rotational speed of the valve 3. That is, the pressure in the reservoir 1a cannot reach P₁ and P₂ when the valve 3 is run faster than some critical rotational speed.

Provided the mass flow controller is operated at a lower speed than the critical rotational speed, the amount of fluid contained in the reservoir 1a per cycle will be known and, more importantly will be known to be and remain constant, irrespective of the rotational speed.

The control unit needs to limit the driving force supplied from the driving means on the basis of the pressure in the reservoir 1a so that the valve 3 cannot rotate faster than the critical rotational speed corresponding to the range of the pressure in the reservoir 1a.

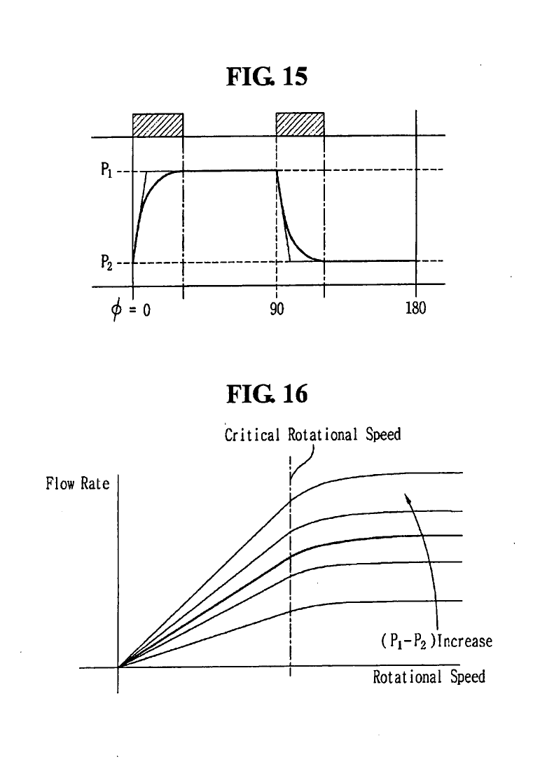

FIG. 15 shows the pressure change in the reservoir 1a in FIG. 5 when the rotational speed of the valve is considerably lower than the critical rotational speed.

As shown in the figure, when the rotational speed is well below the critical rotational speed, then there is more than sufficient time for the reservoir 1a to attain P₁ on the pressurization part of the cycle and drop to P₂ on the depressurization part of the cycle.

FIG. 16 shows the relation between the rotational speed of the valve and the flow rate, wherein the flow rate is affected by the difference between the upstream pressure P₁ and the downstream pressure P₂.

As shown in the figure, the flow rate has a linear relation with the rotational speed until the rotational speed of the valve 3 increases up to the critical rotational speed.

This means that the flow rate is affected by the rotational speed of the valve 3 and the pressure in the reservoir 1a. Therefore, in the mass flow controller operating in a certain range of the pressure, the wanted value of the flow rate can be attained by providing the valve 3 with the driving force corresponding to the range of the pressure under the control of the control unit.

For example, provided that the valve is run below the critical rotational speed, and the flow rate and P₂ are fixed values, the wanted flow rate can be attained with only a small driving force if P₁ is large, but a large driving force is required if P₁ is small.

The mass flow passing through the mass flow controller will be computed from simple thermodynamic relationships. For each complete cycle, the mass flow is given by
Mass flow=2×R×T×V×(P₁⁻¹−P₂⁻¹) for perfect gas,
or
=2×constant×V×(P₁^{-ν}−P₂^{-ν}) for a polytropic process,
where R=universal gas constant, T=absolute temperature, and ν=polytropic expansion coefficient.

Because the valve operates twice in one complete 360 degrees rotation, the factor 2 is used in the above expressions.

Experimental work is required to determine the critical speed and whether the critical speed is itself a function of (P₁−P₂).

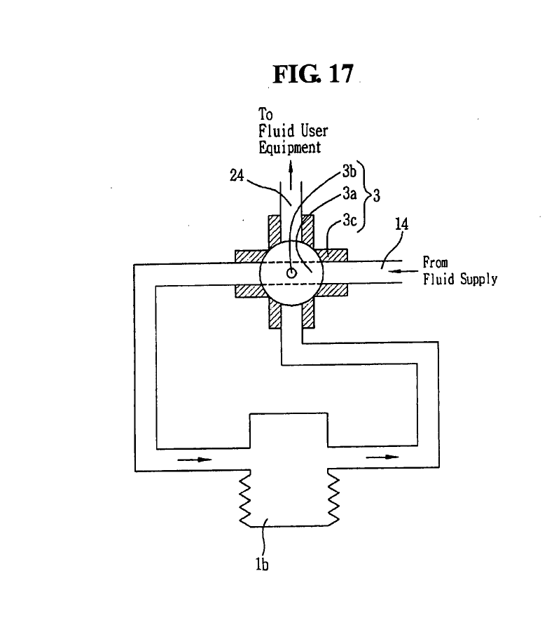

FIG. 17 schematically shows a concept of a mechanical synchronized time-based mass flow controller for incompressible fluid according to yet another embodiment of the present invention.

For incompressible fluid, the volume of the reservoir 1b must be allowed to vary in a cycle. For example, a bellows type reservoir in FIG. 17, an elastic membrane type reservoir and a piston-cylinder type reservoir can be used as the reservoir 1b of the present invention.

When the passage 3a is communicated with the inlet line 14 and then the inlet line 14 is opened, the reservoir volume is connected to the high-pressure supply P₁. Fluid begins to flow into the reservoir 1b, until the inlet line 14 is closed. When the inlet line 14 is closed, the total volume of the reservoir 1b reaches V₁.

Later, when the valve 3 is rotated to reach φ=90°, and thus the passage 3a is communicated with the outlet line 24 and the outlet line 24 is opened, the reservoir 1b is connected to the low pressure, P₂. Fluid starts to flow from the reservoir 1b to the fluid user equipment. When the outlet line 24 is closed, the total volume of the reservoir 1b is V₂.

Although not shown, a spring can preferably be installed on the bottom of the bellows to assist contraction/restoration of the bellows.

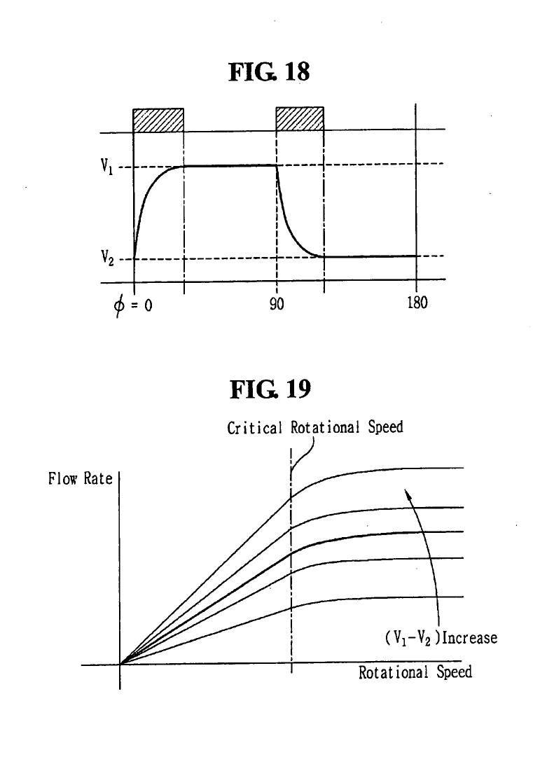

FIG. 18 shows the volume change of the reservoir 1b in FIG. 17.

Assuming that the valve 3 and the reservoir 1b have such a fast response that the reservoir 1b attains the maximum volume possibly by the time the inlet line 14 closes, and the reservoir 1b attains the minimum volume when or before the outlet line 24 closes, then the volume-time characteristics of the reservoir 1b will look like FIG. 18.

This is similar in shape to the pressure-time characteristics of the reservoir 1a of the mass flow controller for compressible fluid in FIG. 13.

Note that it is not necessary for the pressure in the reservoir 1b to attain the maximum pressure, P1, and the minimum pressure, P2, for the system to operate in the linear region. However, It is necessary for the reservoir 1b to have reached the maximum volume, V₁, and the minimum volume, V₂.

Assuming that this can be achieved, provided the rotational speed of the ball valve is below the critical value, the volume flow rate for this system is then simply given by:
Volume flow rate=2×(V₁−V₂) per synchronized rotation,
or
Mass flow rate=2×(V₁−V₂)×ρ per synchronized rotation,
where ρ =density of fluid.

FIG. 19 shows the relation between the rotational speed of the valve and the flow rate, wherein the flow rate is affected by the difference between V₁ and V₂.

As shown in the figure, by changing the rotational speed, the mass flow rate can be altered in a linear fashion. Further, extension of the operating range can be achieved by altering size of the reservoir 1b, (V₁−V₂). For a high mass flow rate, a large (V₁−V₂) value is needed, while accurate MFC for incompressible flows can be achieved with relatively small (V₁−V₂).

This means that the flow rate is affected by the rotation speed of the valve 3 and the volume of the reservoir 1b. Therefore, in the flow controller with the reservoir working in the preset volume range, the required flow rate can be obtained by providing the valve 3 with a driving force based on the preset volume range.

For example, assuming that the valve 3 is rotated at a lower speed than the critical speed and the amount of the flow rate and V₂ is fixed, the flow rate can be obtained with a small driving force if V₁ is large. However, if V₁ is small, a large driving force for increasing the rotational speed of the valve 3 is necessary.

According to the above-described embodiments of the present invention, it is possible to provide a mass flow controller which keeps advantages of the inventor's previous inventions and at the same time has excellent controllability.

In addition, it is possible to provide a mass flow controller which has high reliability by minimizing possibility of control errors.

In addition, it is possible to provide a mass flow controller which is inexpensive and compact and can provide silent environment by minimizing vibration and noise.

1. A mechanical synchronized time-based mass flow controller comprising:
a reservoir;
an inlet line communicated with the reservoir through which fluid flows into the reservoir;
an outlet line communicated with the reservoir through which the fluid flows out from the reservoir;
a valve having a passage through which the fluid passes and operating in a mechanical cycle which includes an inlet line open period when the passage is communicated with the inlet line and the inlet line is in an open state and an outlet line open period when the passage is communicated with the outlet line and the outlet line is in an open state according to change of position of the passage, the inlet line open period and the outlet line open period coming out of phase with each other so that the inlet line can be opened when the outlet line is in a closed state and the outlet line can be opened when the inlet line is in a closed state; and
a control unit controlling cycle rate of the valve and/or mass/volume of the fluid stored and discharged at the reservoir per unit opening/closing cycle of the valve, to control mass/volume flow rate of the outflow fluid from the reservoir.

2. The mechanical synchronized time-based mass flow controller as claimed in claim 1,
wherein the valve is a rotary type valve.

3. The mechanical synchronized time-based mass flow controller as claimed in claim 2,
wherein the inlet line and the outlet line cross each other,
the valve is a ball valve installed at a place where the inlet line and the outlet line cross each other, and
the ball valve is rotated to alternately open the inlet line and the outlet line out of phase.

4. The mechanical synchronized time-based mass flow controller as claimed in claim 2,
wherein the passage of the valve has an opening facing in the direction of a rotation shaft of the valve and meets the inlet line and the outlet line out of phase on the rotation route of the passage, and
the valve is rotated to alternately open the inlet line and the outlet line out of phase.

5. The mechanical synchronized time-based mass flow controller as claimed in claim 1,
wherein the inlet line and/or outlet line are installed in the plural number respectively.

6. The mechanical synchronized time-based mass flow controller as claimed in claim 5,
wherein different fluids are arranged to flow into the reservoir through plural inlet lines.

7. The mechanical synchronized time-based mass flow controller as claimed in claim 1,
wherein the valve has plural passages.

8. The mechanical synchronized time-based mass flow controller as claimed in claim 1,
comprising plural valves installed on a single shaft,
wherein each valve alternately opens the corresponding inlet line and the corresponding outlet line out of phase.

9. The mechanical synchronized time-based mass flow controller as claimed in claim 8,
wherein different fluids are arranged to flow into the reservoir through plural inlet lines.

10. The mechanical synchronized time-based mass flow controller as claimed in any one of claim 1,
wherein the control unit controls the amount of driving force provided to the valve, to control the mass/volume flow rate of the outflow fluid from the reservoir.

11. A mechanical synchronized time-based mass flow controller comprising:
a reservoir;
an inlet line communicated with the reservoir through which fluid flows into the reservoir;
an outlet line communicated with the reservoir through which the fluid flows out from the reservoir;
a valve rotating on a single shaft in a mechanical cycle which includes an inlet line open period when the inlet line is in an open state and an outlet line open period when the outlet line is in an open state, the inlet line open period and the outlet line open period coming out of phase with each other so that the inlet line can be opened when the outlet line is in a closed state and the outlet line can be opened when the inlet line is in a closed state; and
a control unit controlling cycle rate of the valve and/or mass/volume of the fluid stored and discharged at the reservoir per unit opening/closing cycle of the valve, to control mass/volume flow rate of the outflow fluid from the reservoir.

12. The mechanical synchronized time-based mass flow controller as claimed in claim 11,
wherein the valve has both an inlet valve and an outlet valve installed separately on the single shaft and rotating in one body, and
the inlet valve opens the inlet line and the outlet valve opens the outlet line out of phase.

13. The mechanical synchronized time-based mass flow controller as claimed in any one of claim 11,
wherein the control unit controls the amount of driving force provided to the valve, to control the mass/volume flow rate of the outflow fluid from the reservoir.

14. The mechanical synchronized time-based mass flow controller as claimed in claim 13,
comprising a pressure sensor detecting pressure in the reservoir,
wherein the control unit determines the amount of the driving force provided to the valve based on the pressure in the reservoir detected by the pressure sensor.

15. The mechanical synchronized time-based mass flow controller as claimed in claim 14,
wherein the valve is provided with such an amount of the driving force that the cycle rate of the valve is lower than a critical cycle rate below which the pressure in the reservoir can rise to upstream pressure of the inlet line and drop to downstream pressure of the outlet line.

16. The mechanical synchronized time-based mass flow controller as claimed in claim 13,
wherein the fluid is incompressible fluid, and
volume of the reservoir is changed in a cycle.

17. The mechanical synchronized time-based mass flow controller as claimed in claim 16,
comprising a volume sensor detecting the volume of the reservoir,
wherein the control unit determines the amount of the driving force provided to the valve based on the volume of the reservoir detected by the volume sensor.
